(19) United States
(12) Patent Application Publication
(10) Pub. No.: US 2023/0379435 A1
(43) Pub. Date: Nov. 23, 2023

(54) MEETING MANAGEMENT APPARATUS, MEETING MANAGEMENT METHOD, AND NON-TRANSITORY COMPUTER-READABLE MEDIUM

(71) Applicant: V-CUBE, INC., Tokyo (JP)

(72) Inventors: Yosuke KAMEZAKI, Tokyo (JP); Hironori NURISHI, Tokyo (JP); Ei SOU, Tokyo (JP); Ken KOSEKI, Tokyo (JP)

(21) Appl. No.: 18/200,571

(22) Filed: May 23, 2023

Related U.S. Application Data
(63) Continuation of application No. PCT/JP2022/045598, filed on Dec. 12, 2022.

(30) Foreign Application Priority Data
May 20, 2022 (JP) 2022-082839

(51) Int. Cl. H04N 7/15

(52) U.S. Cl. CPC H04N 7/15

(57) ABSTRACT

A meeting management apparatus managing a plurality of group meetings that each of a plurality of communication terminals can attend, including: an information acquiring part that acquires information in which (i) an individual meeting which is a group meeting selected from among a plurality of group meetings and (ii) a plurality of attendee terminals that are communication terminals attending the individual meeting among the plurality of communication terminals are associated with each other; and a terminal control part that executes, in parallel, the individual meeting for transmitting and receiving voices between the plurality of attendee terminals and a general meeting for transmitting voices from a predetermined source terminal to the plurality of communication terminals.

### CROSS-REFERENCE TO RELATED APPLICATIONS

The present application is a continuation application of International Application number PCT/JP2022/45598, filed on Dec. 12, 2022, which claims priority under 35 U.S.C § 119(a) to Japanese Patent Application No. 2022-082839, filed on May 20, 2022. The contents of this application are incorporated herein by reference in their entirety.

### BACKGROUND OF THE INVENTION

The present disclosure relates to a meeting management apparatus, a meeting management method, and a computer-readable non-transitory storage medium for managing meetings performed via a network.

There is known a technique for performing a meeting by transmitting and receiving audio signals via a network. Japanese Unexamined Patent Application Publication No. 2020-144476 discloses a meeting system that enables the performance of a plurality of group meetings.

### BRIEF SUMMARY OF THE INVENTION

In a lecture or a business meeting through a network, there are cases where a general meeting, in which a presentation is given to many users, and a plurality of individual meetings, in which some users have a conversation among themselves, are performed. Conventionally, in a group meeting held via the network, a communication terminal of a user can attend only one of a general meeting and an individual meeting. For this reason, it was inconvenient because the user could not listen to a general presentation while having conversations with other users, such as at a face-to-face lecture or business meeting.

The present disclosure focuses on this point, and its object is to improve user convenience in a plurality of group meetings via a network.

A meeting management apparatus according to a first aspect of the present disclosure is a meeting management apparatus managing a plurality of group meetings that each of a plurality of communication terminals can attend, the meeting management apparatus including: an information acquiring part that acquires information in which (i) an individual meeting, which is a group meeting selected from among a plurality of group meetings, and (ii) a plurality of attendee terminals that are communication terminals attending the individual meeting among the plurality of communication terminals are associated with each other; and a terminal control part that executes, in parallel, the individual meeting for transmitting and receiving voices between the plurality of attendee terminals and a general meeting for transmitting voices from a predetermined source terminal to the plurality of communication terminals.

A meeting management method according to a second aspect of the present disclosure is a meeting management method for managing a plurality of group meetings that each of a plurality of communication terminals can attend, the method executed by a processor and including: acquiring information in which (i) an individual meeting which is a group meeting selected from among a plurality of group meetings and (ii) a plurality of attendee terminals that are communication terminals attending the individual meeting among the plurality of communication terminals are associated with each other; and executing, in parallel, the individual meeting for transmitting and receiving voices between the plurality of attendee terminals and a general meeting for transmitting voices from a predetermined source terminal to the plurality of communication terminals.

A non-transitory storage medium according to a third aspect of the present disclosure is a computer-readable non-transitory storage medium storing a program for managing a plurality of group meetings that each of a plurality of communication terminals can attend, the program causing a processor to execute: acquiring information in which (i) an individual meeting which is a group meeting selected from among a plurality of group meetings and (ii) a plurality of attendee terminals that are communication terminals attending the individual meeting among the plurality of communication terminals are associated with each other; and executing, in parallel, the individual meeting for transmitting and receiving voices between the plurality of attendee terminals and a general meeting for transmitting voices from a predetermined source terminal to the plurality of communication terminals.

### BRIEF DESCRIPTION OF THE DRAWINGS

FIG. 1 shows a configuration of a meeting management system.

FIG. 2 shows an example of a screen displayed on a user terminal.

FIG. 3 shows an example of the screen displayed on the user terminal.

FIG. 4 shows a configuration of a meeting management apparatus and the user terminal.

FIG. 5 shows an example of a screen for notifying that the general meeting will start in the user terminal.

FIG. 6 shows an example of a screen for displaying data of an individual meeting and a general meeting in an attendee terminal.

FIG. 7 shows another example of the screen for displaying the data of the individual meeting and the general meeting in the attendee terminal.

FIG. 8 shows another example of the screen for displaying the data of the individual meeting and the general meeting in the attendee terminal.

FIG. 9 is a flowchart showing an example of a flow of processing in the meeting management apparatus.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### [Outline of a Meeting Management System S]

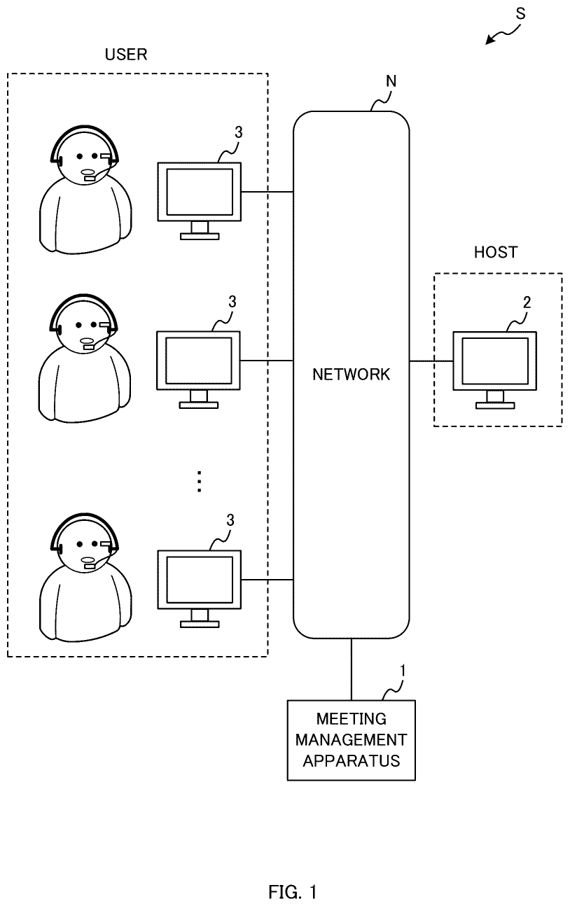

FIG. 1 shows a configuration of a meeting management system S. The meeting management system S is a system for enabling a plurality of group meetings to be performed online in parallel. The meeting management system S is suitable for an online event where a plurality of users are divided into a plurality of groups for the purpose of business, research, interaction with others, learning, and the like, for example, but the application of the meeting management system S is not limited.

In the example shown in FIG. 1, the meeting management system S includes a meeting management apparatus 1, a host terminal 2, and a plurality of user terminals 3. The meeting management apparatus 1 is a device for managing a plurality of group meetings that each of a plurality of user terminals 3 can attend. The meeting management apparatus 1 is a server that executes data processing for realizing a plurality of group meetings, for example.

The meeting management apparatus 1 causes the plurality of user terminals 3 to display a screen for attending the plurality of group meetings via a network N so that a plurality of users can attend the plurality of group meetings. The meeting management apparatus 1 provides a user terminal 3 registered in advance with a web application, thereby allowing the user terminal 3 to attend the group meeting. Details of the meeting management apparatus 1 will be described later.

The host terminal 2 is a communication terminal used by an organizer of an event including the plurality of group meetings, and is, for example, a computer, a tablet terminal, or a smartphone. The host terminal 2 includes an input part such as a touch panel, a microphone, or a camera for inputting information, and an output part such as a liquid crystal display or a speaker for outputting information. The host terminal 2 is operated by the organizer to transmit and receive various types of data to and from the user terminal 3 via the meeting management apparatus 1, for example. The host terminal 2 transmits, to the meeting management apparatus 1, image data for a presentation, audio data generated by the organizer, and text data input by the organizer, for example.

The user terminal 3 is a communication terminal used by a user who will attend the event including the plurality of group meetings, and is, for example, a personal computer, a tablet terminal, or a smartphone. The user terminal 3 includes an input part such as a touch panel, a microphone, and a camera for inputting information, and an output part such as a liquid crystal display and a speaker for outputting information. The user terminal 3 is operated by the user to transmit and receive various types of data to and from the host terminal 2 or another user terminal 3 via the meeting management apparatus 1, for example. The user terminal 3 receives image data, audio data, and text data transmitted from the host terminal 2 or another user terminal 3, and displays the received data on the screen.

The meeting management apparatus 1 generates various types of data for executing the plurality of group meetings, and displays the generated, various types of data on the screen of the user terminal 3. The meeting management apparatus 1 displays an image indicating booths corresponding to the plurality of group meetings that can be attended using the plurality of user terminals 3 on the screen of the user terminal 3, and allows the user to select a group meeting that he/she wishes to attend, for example. A group meeting in this embodiment corresponds to a booth or a table in an event venue, and the user can attend a group meeting applied for previously or can shift to another group meeting by operating the user terminal 3.

The user can communicate with another user by sending and receiving voices to and from another user using a voice call function or by sending and receiving text messages to and from another user using a chat feature in the user terminal 3. Further, the user can view a presentation or a lecture transmitted from a predetermined source terminal (e.g., the host terminal 2 or any one of the plurality of user terminals 3) in the user terminal 3.

### [Examples of Screens]

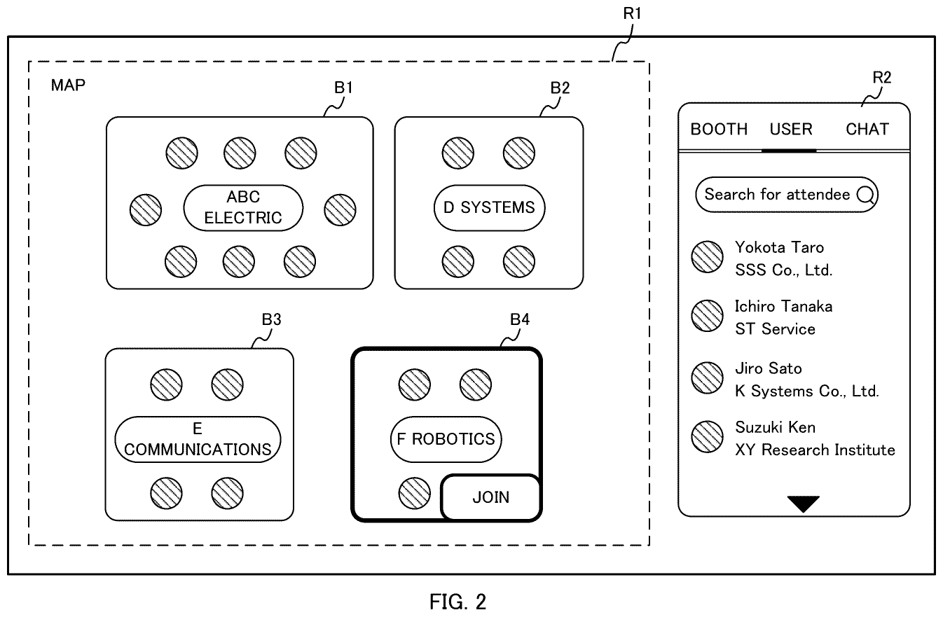

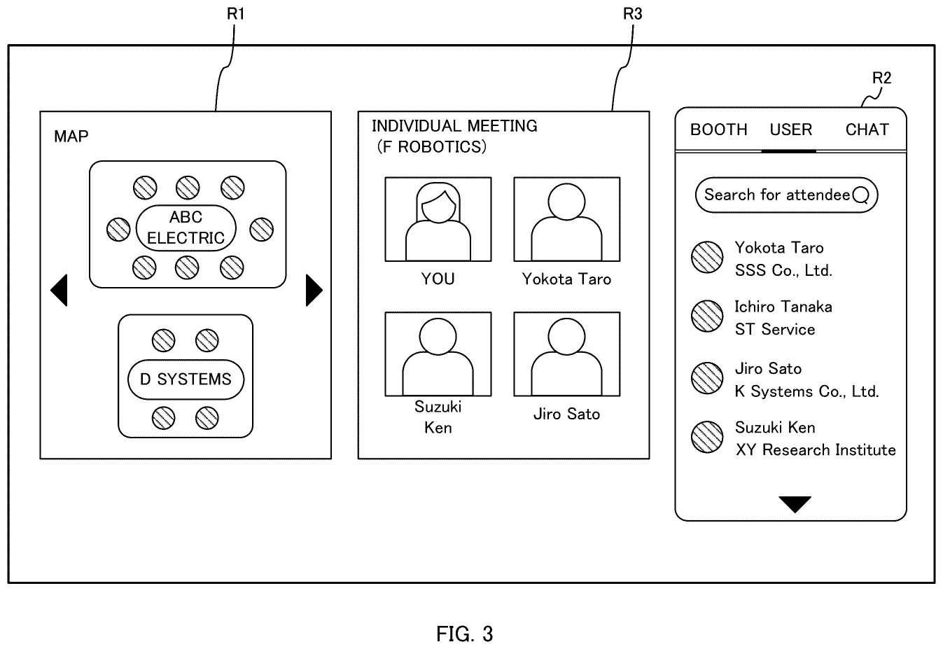

FIGS. 2 and 3 show examples of screens displayed on the user terminal 3. FIG. 2 is a screen for selecting a group meeting that a user will attend. The names of exhibitor companies organizing group meetings are displayed in an area R1 of FIG. 2, as an outline of the plurality of group meetings. The following group meetings are displayed in the example of FIG. 2: a group meeting of ABC Electric as a booth B1; a group meeting of D Systems as a booth B2; a group meeting of E Communications as a booth B3; and a group meeting of F Robotics as a booth B4.

An image of a circle with diagonal lines shown in each booth is an icon image corresponding to a user. Although the icon image in FIG. 2 is represented by diagonal lines, the icon image may be an image including information for identifying a user, such as a face image of the user.

The user can attend the group meeting corresponding to a selected booth by performing an operation for selecting a booth to attend on the screen of FIG. 2 (for example, a click operation or a touch operation). FIG. 2 shows a state where the user has selected a group meeting of the booth B4.

Various types of information that the user can utilize are displayed on an area R2 of FIG. 2. In the area R2, a list of booths that the user can attend, a list of users who are attending the event, chat using text messages, and the like are displayed, for example. In FIG. 2, the list of users who are attending the event is displayed in the area R2.

If the user selects a display area “Join” displayed on the booth B4 selected on the screen of FIG. 2, it is determined that the user is to attend the group meeting. A group meeting for transmitting and receiving voices between a plurality of user terminals 3 is referred to as an individual meeting.

The user terminal 3 displays a screen in the individual meeting. FIG. 3 shows an example of a screen in the individual meeting. Similar to FIG. 2, the outline of the plurality of group meetings is displayed in an area R1 of FIG. 3. Similar to FIG. 2, the list of users who are attending the event is displayed in an area R2 of FIG. 3. Image data of the user who is attending the individual meeting is displayed in an area R3 of FIG. 3. The image data is captured by a camera included in the user terminal 3.

The meeting management system S according to the present embodiment executes, in parallel, (i) the individual meeting in which voices are transmitted and received between the plurality of user terminals 3 and (ii) a general meeting in which voices are transmitted from a predetermined source terminal to all user terminals 3 attending the event, by performing processing described later. As a result, the meeting management system S enables the user to view the general meeting while having conversations in the individual meeting, and can therefore improve user convenience.

### [Outlines of the Meeting Management Apparatus 1 and the User Terminal 3]

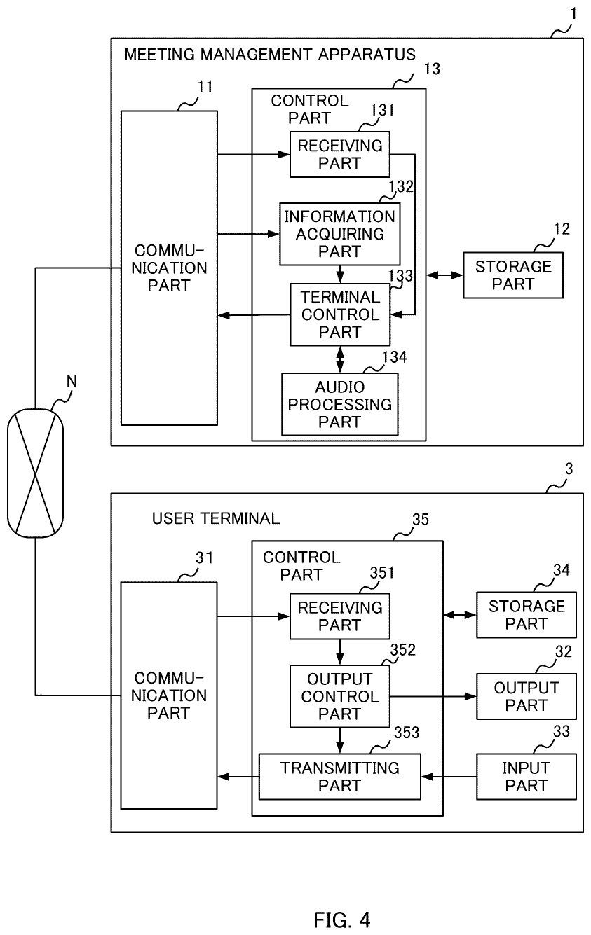

FIG. 4 shows configurations of the meeting management apparatus 1 and the user terminal 3. Since the host terminal 2 has a configuration equivalent to that of the user terminal 3, a description thereof will be omitted.

The meeting management apparatus 1 includes a communication part 11, a storage part 12, and a control part 13. The control part 13 includes a receiving part 131, an information acquiring part 132, a terminal control part 133, and an audio processing part 134.

The communication part 11 includes a communication controller for transmitting and receiving various types of data via the network N. For example, the communication part 11 notifies the receiving part 131 of data for a setting operation received from the host terminal 2 or the user terminal 3. Further, for example, the communication part 11 notifies the information acquiring part 132 of image data or sound data generated in a group meeting. Further, the communication part 11 transmits the image data or the sound data notified from the terminal control part 133 to the host terminal 2 or the user terminal 3, for example.

The storage part 12 includes computer-readable non-transitory storage media such as a Read Only Memory (ROM), a Random Access Memory (RAM), and a Solid State Drive (SSD). The storage part 12 stores a program executed by the control part 13. The storage part 12 stores various types of data related to the group meeting.

The control part 13 includes a processor such as a Central Processing Unit (CPU). The control part 13 functions as the receiving part 131, the information acquiring part 132, the terminal control part 133, and the audio processing part 134 by executing the program stored in the storage part 12. Details of the receiving part 131, the information acquiring part 132, the terminal control part 133, and the audio processing part 134 will be described later.

The user terminal 3 includes a communication part 31, an output part 32, an input part 33, a storage part 34, and a control part 35. The control part 35 includes a receiving part 351, an output control part 352, and a transmitting part 353.

Similar to the communication part 11, the communication part 31 includes a communication controller for transmitting and receiving various types of data via the network N. For example, the communication part 31 receives image data and sound data transmitted from the host terminal 2 and other user terminals 3 via the network N and the meeting management apparatus 1, and notifies the receiving part 351 of the received data. The communication part 31 acquires, from the transmitting part 353, sound data based on voice input by the user using the user terminal 3, text data input by the user using the user terminal 3, and the like, and then transmits the acquired data, for example.

The output part 32 includes a display part such as a liquid crystal display that displays image data, and a sound output part such as a speaker that outputs sound data, for example. In response to an instruction from the output control part 352, the output part 32 displays an image related to the group meeting such as shown in FIGS. 2 and 3 on the liquid crystal display, and outputs, to the speaker, sounds generated in the group meeting that the user is attending, for example.

The input part 33 includes (i) an operation part such as a touch panel that receives an operation made by the user, (ii) a sound input part such as a microphone that inputs sound data, and (iii) an imaging part such as a camera that captures a predetermined imaging range to generate image data, for example. The input part 33 notifies the transmitting part 353 of the input data.

The storage part 34 includes non-transitory computer-readable storage media such as a ROM, a RAM, and an SSD. The storage part 34 stores a program executed by the control part 35.

The control part 35 includes a processor such as a CPU, for example. The control part 35 functions as the receiving part 351, the output control part 352, and the transmitting part 353 by executing a program stored in the storage part 34.

The receiving part 351 receives various types of data from the meeting management apparatus 1 via the communication part 31. The receiving part 351 inputs the received data to the output control part 352. The output control part 352 causes the output part 32 to output the data transmitted by the meeting management apparatus 1. For example, the output control part 352 causes an image based on image data to be displayed on the liquid crystal display, and causes the speaker to output sound based on sound data. The transmitting part 353 transmits the data input by the user via the input part 33 to the meeting management apparatus 1.

### [Configuration of the Control Part 13]

Next, a configuration and function of the control part 13 will be described in detail. The receiving part 131 receives various operations from the host terminal 2 and the user terminal 3 via the communication part 11. The receiving part 131 receives, from the user terminal 3, a selection operation for selecting at least one of the plurality of group meetings, for example. The receiving part 131 receives an operation of selecting the group meeting by acquiring information for identifying a group meeting selected by the user from among the plurality of group meetings, as displayed on the screen shown in FIG. 2.

The receiving part 131 receives an operation to “join” by acquiring information for specifying that the user has performed an operation to “join” on the screen shown in FIG. 2. The user terminal 3 used by the user who performed the operation to “join” attends the group meeting corresponding to the operation among the plurality of group meetings. Hereinafter, a group meeting for transmitting and receiving voices between the plurality of user terminals 3 is referred to as an individual meeting, a user terminal 3 attending the individual meeting among the plurality of user terminals 3 is referred to as an attendee terminal 3A, and a user using the attendee terminal 3A is referred to as an attendee. The receiving part 131 stores, in the storage part 12, attendance information in which the individual meeting and a plurality of attendee terminals 3A attending the individual meeting are associated with each other.

The information acquiring part 132 acquires various types of data from the user terminal 3 via the communication part 11. The information acquiring part 132 acquires, from the user terminal 3, sound data indicating sounds generated by the user of this terminal, and acquires image data of the user of this terminal captured by a camera included in the user terminal 3, for example. The information acquiring part 132 notifies the terminal control part 133 of the acquired sound data and image data.

Further, the information acquiring part 132 acquires, from the storage part 12, attendance information in which (i) an individual meeting, which is a group meeting selected from among the plurality of group meetings, and (ii) a user terminal 3 attending this individual meeting are associated with each other.

The terminal control part 133 transmits various types of data to the user terminal 3 via the communication part 11, thereby causing various screens to be displayed on the user terminal 3. The terminal control part 133 displays the screens shown in FIGS. 2 and 3 on the user terminal 3 by transmitting data necessary for the user terminal 3 to display the screens shown in FIGS. 2 and 3, for example. Then, the terminal control part 133 executes the group meeting by relaying various types of data transmitted from the user terminal 3, and allowing the users to exchange various types of information.

The terminal control part 133 executes an individual meeting by transmitting audio data and image data transmitted from any one of the attendee terminals 3A attending the individual meeting indicated by the attendance information acquired by the information acquiring part 132 to other attendee terminals 3A attending the individual meeting, for example. The image data transmitted from the attendee terminal 3A is image data of an attendee captured by a camera included in the attendee terminal 3A, for example.

Hereinafter, a process for the meeting management system S to execute an individual meeting and a general meeting in parallel will be described in detail. The receiving part 131 receives a start operation for starting a general meeting from the host terminal 2, for example. The general meeting is a group meeting in which voices are transmitted from a predetermined source terminal to all of the user terminals 3 attending an event. Although an example in which the host terminal 2 functions as a source terminal in the general meeting will be described in the present embodiment, any user terminal 3 selected from among a plurality of user terminals 3 may function as the source terminal in the general meeting.

On condition that the receiving part 131 receives an operation for starting the general meeting, the terminal control part 133 transmits data indicating that the general meeting will start to the plurality of user terminals 3, thereby notifying the users that the general meeting will start.

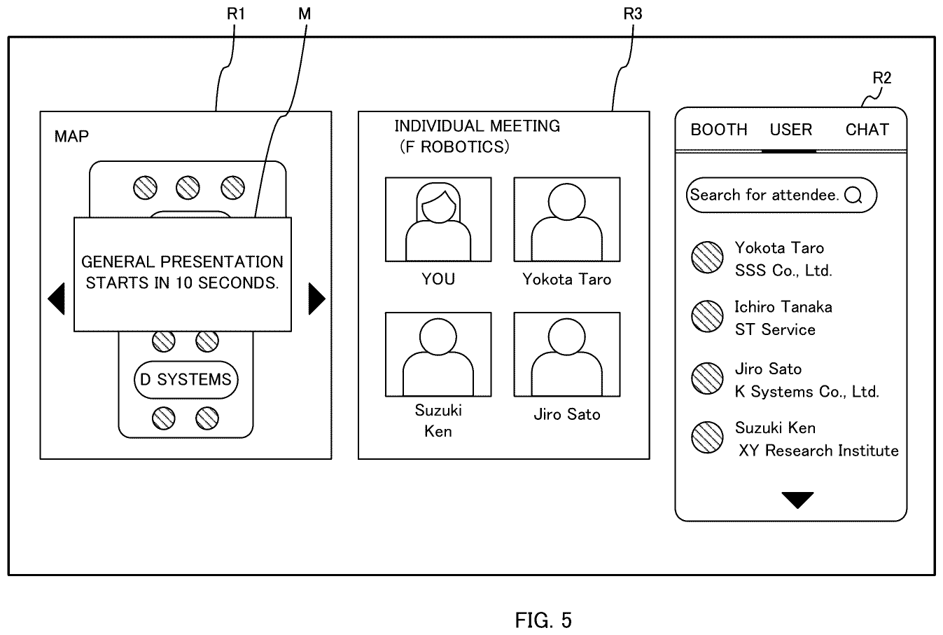

FIG. 5 shows an example of a screen for notifying that the general meeting will start in the user terminal 3. Similar to FIG. 3, the screen of FIG. 5 includes the area R1 for displaying the outline of the plurality of group meetings, the area R2 for displaying the list of users who are attending the event, and the area R3 for displaying the image data of each of the plurality of users attending the individual meeting. Further, a message M indicating that the general meeting will start is displayed in the area R1 of FIG. 5. This enables the user to know that the general meeting will start while he/she is holding an individual meeting with other users.

On condition that the receiving part 131 receives an operation for starting the general meeting, the terminal control part 133 executes (i) an individual meeting for transmitting and receiving voices between the plurality of attendee terminals 3A on the basis of the attendance information acquired by the information acquiring part 132 and (ii) a general meeting for transmitting voices from a predetermined source terminal (e.g., the host terminal 2 or any of the plurality of user terminals 3) to the plurality of user terminals 3, in parallel.

The terminal control part 133 may change any one of the attendee terminals 3A attending the individual meeting to the source terminal of the general meeting. In this case, the receiving part 131 receives a selection of any one of the plurality of attendee terminals 3A (for example, the names of the attendees using the attendee terminals 3A) in either the host terminal 2 or any one of the plurality of user terminals 3. The terminal control part 133 causes the attendee terminal 3A selected from among the plurality of attendee terminals 3A to exit the individual meeting and sets this attendee terminal 3A as the source terminal, and starts the general meeting. By doing this, even when an attendee terminal 3A is attending the individual meeting, the meeting management apparatus 1 can change the attendee terminal 3A to the source terminal of the general meeting.

While the individual meeting and the general meeting are being executed in parallel, the information acquiring part 132 acquires various types of data from the source terminal and the attendee terminal 3A via the communication part 11. For example, the terminal control part 133 executes the individual meeting by transmitting the audio data and the image data transmitted from any one of the attendee terminals 3A attending the individual meeting indicated by the attendance information acquired by the information acquiring part 132 to other attendee terminals 3A attending the individual meeting. The image data transmitted from the attendee terminal 3A is image data of an attendee captured by a camera included in the attendee terminal 3A, for example.

Further, the terminal control part 133 transmits the audio data and the image data transmitted from the source terminal to all of the user terminals 3 including the attendee terminal 3A, for example. The image data transmitted from the source terminal is image data of an organizer or a user captured by a camera included in the source terminal, or image data for a presentation, for example.

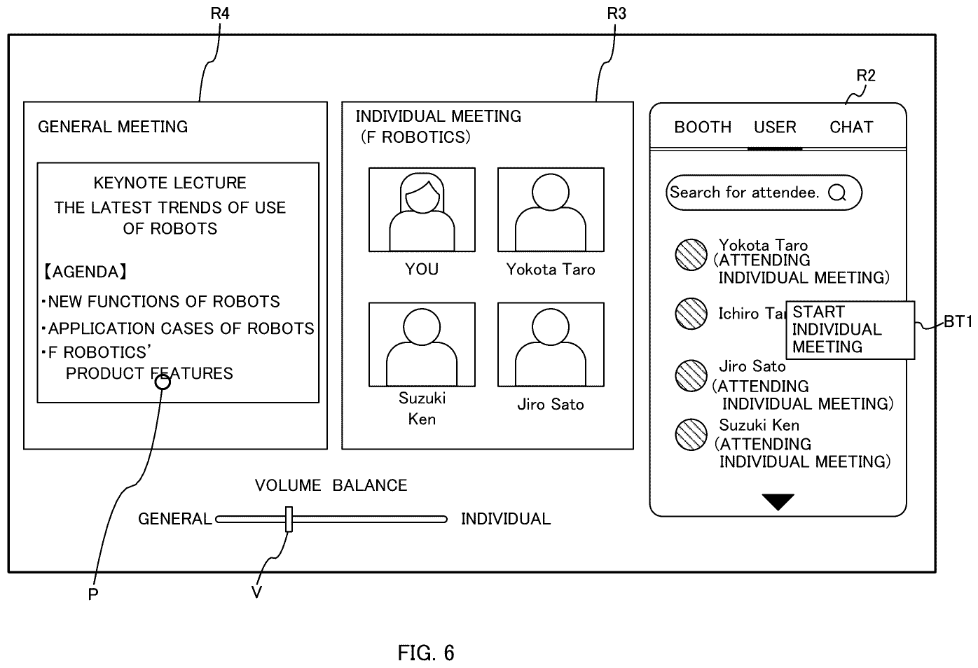

FIG. 6 shows an example of a screen for displaying data of the individual meeting and the general meeting in the attendee terminal 3A. The screen of FIG. 6 includes an area R2 for displaying the list of users who are attending the event, an area R3 for displaying the image data of each of the plurality of users attending the individual meeting, and an area R4 for displaying image data transmitted from the source terminal in the general meeting.

In a state where the attendee terminal 3A is displaying the screen of FIG. 6, an attendee using the attendee terminal 3A can listen to voices in the individual meeting output from the attendee terminal 3A and voices in the general meeting at the same time. Further, the attendee using the attendee terminal 3A can view data corresponding to the individual meeting displayed in the area R3 and data corresponding to the general meeting displayed in the area R4 at the same time.

By relaying data between the plurality of attendee terminals 3A attending the individual meeting and relaying data from the source terminal to the plurality of user terminals 3 in this manner, the terminal control part 133 executes the individual meeting and the general meeting in parallel. As a result, the meeting management apparatus 1 enables the user to view the general meeting while having conversations in the individual meeting, and can therefore improve user convenience.

An example in which the general meeting is started while the individual meeting is being held has been described above. In a case where an individual meeting is started while a general meeting is being held, the terminal control part 133 similarly starts executing the individual meeting and the general meeting in parallel.

It is desirable that the terminal control part 133 disables transmission of at least one of an image or a voice from the attendee terminal 3A to the general meeting and maintains transmission of at least one of an image or a voice from the attendee terminal 3A to the individual meeting, on condition that the individual meeting and the general meeting are performed in parallel. In this case, the terminal control part 133 transmits the audio data and the image data transmitted from any one of the attendee terminals 3A attending the individual meeting to other attendee terminals 3A attending the individual meeting, but does not transmit the audio data and the image data to user terminals 3 not attending the individual meeting. By doing this, the attendee of the individual meeting can continue conversations within the individual meeting without interrupting the general meeting.

Further, the terminal control part 133 may enable the transmission of at least one of the image or the voice from the attendee terminal 3A to the general meeting on condition that a predetermined operation (for example, holding down a predetermined key) is performed by an attendee in the attendee terminal 3A when the individual meeting and the general meeting are performed in parallel and the transmission of at least one of the image or the voice from the attendee terminal 3A to the general meeting is disabled. By doing this, the attendee of the individual meeting can speak or the like in the general meeting as necessary.

In addition, the terminal control part 133 displays, in the attendee terminal 3A, a pointer P indicating a position designated in the source terminal. The receiving part 131 receives the designation of the position by an operation of a mouse or the like in the source terminal of the general meeting, for example. The terminal control part 133 causes the pointer P corresponding to the designated position to be displayed in the area R4 in which the image data of the general meeting is displayed in all the user terminals 3, including the plurality of attendee terminals 3A, attending the general meeting. The pointer P is a symbol such as an arrow, for example. As a result, the organizer or the user who is transmitting the general meeting can notify all the users about the position that he/she wishes the users to draw attention to on the image data of the general meeting, and can therefore proceed with the general meeting smoothly.

Further, the terminal control part 133 causes a user terminal 3 attending the individual meeting and a user terminal 3 not attending the individual meeting, among the plurality of user terminals 3, to be displayed in different display modes, in at least one of the attendee terminal 3A or the source terminal. In the example of FIG. 6, in the area R2 in which the list of users attending the event is displayed, the terminal control part 133 displays a label “attending individual meeting” near the name of the user using the user terminal 3 attending the individual meeting, and does not display this label near the names of the users using the user terminals 3 not attending the individual meeting. Further, the terminal control part 133 may change a color, size, pattern, and the like of the name of the user using the user terminal 3, depending on whether or not the user terminal 3 is attending the individual meeting. By doing this, the organizer or the user can easily grasp whether other users are attending the individual meeting.

The audio processing part 134 changes the volume of the individual meeting and the volume of the general meeting in the attendee terminal 3A according to a set value set in the attendee terminal 3A. A volume setting column V for receiving a setting of a single set value corresponding to a ratio of the volume of the individual meeting to the volume of the general meeting is displayed in the screen of FIG. 6, for example. The attendee can set a value corresponding to a position of a bar in the volume setting column V by moving the bar left and right, for example.

The receiving part 131 receives the value set in the volume setting column V as the single set value corresponding to the ratio of the volume of the individual meeting to the volume of the general meeting while the terminal control part 133 is performing the individual meeting and the general meeting in parallel. The audio processing part 134 determines the volume of the individual meeting and the volume of the general meeting in the attendee terminal 3A in accordance with the single set value received by the receiving part 131. For example, the audio processing part 134 increases the volume of the individual meeting and decreases the volume of the general meeting as the set value increases, and decreases the volume of the individual meeting and increases the volume of the general meeting as the set value decreases. After setting the sound data to the volume determined by the audio processing part 134, the terminal control part 133 transmits the sound data of the set volume to the attendee terminal 3A. By doing this, the attendee can easily adjust the balance of the volume of the individual meeting and the volume of the general meeting by simply setting one value.

In addition, regarding the audio data transmitted from the terminal control part 133 to the attendee terminal 3A, the audio processing part 134 may change the volume of at least one of the individual meeting or the general meeting in the attendee terminal 3A depending on whether the terminal control part 133 performs the individual meeting and the general meeting in parallel. The audio processing part 134 reduces the volume of the individual meeting in the attendee terminal 3A or increases the volume of the general meeting on condition that the general meeting starts during the individual meeting, for example. Further, the audio processing part 134 may increase the volume of the individual meeting in the attendee terminal 3A or decrease the volume of the general meeting on condition that the general meeting starts during the individual meeting, for example. By doing this, the meeting management apparatus 1 automatically adjusts the volume according to whether the individual meeting and the general meeting are being performed in parallel, thereby making it easier for the attendee to listen to the voices in the individual meeting and the voices in the general meeting.

Further, the audio processing part 134 may reduce the volume of the general meeting in the attendee terminal 3A on condition that the terminal control part 133 performs the individual meeting and the general meeting in parallel and that voices are transmitted from any one of the plurality of attendee terminals 3A in the individual meeting. By doing this, the meeting management apparatus 1 automatically reduces the volume of the general meeting in response to an attendee speaks in the individual meeting, thereby making it easier for the attendee to listen to the voices in the individual meeting.

Further, the audio processing part 134 may perform a process of removing the voices transmitted in the general meeting from the voices transmitted in the individual meeting, on the sound data transmitted by the terminal control part 133 to the attendee terminal 3A. The audio processing part 134 treats voices transmitted from the source terminal of the general meeting as voices transmitted from one of the attendee terminals 3A of the individual meeting, in a known echo cancellation process performed on voices transmitted from the plurality of attendee terminals 3A attending the individual meeting, for example. As a result, the meeting management apparatus 1 applies the echo cancellation process performed on the voices exchanged among the plurality of attendee terminals 3A on the voices in the general meeting as well, and can therefore prevent or reduce echo and the like that may occur when the voices in the general meeting are input to the microphones included in the plurality of attendee terminals 3A.

In addition, the audio processing part 134 may perform a process of outputting voices of the general meeting and voices of the individual meeting via different channels (for example, a left channel and a right channel) of the sound output part included in the attendee terminal 3A, on the sound data transmitted from the terminal control part 133 to the attendee terminal 3A. By doing this, the meeting management apparatus 1 can make it easier for the attendee to distinguish the voices in the general meeting from the voices in the individual meeting and vice versa, in a situation where the general meeting and the individual meeting are being performed in parallel.

The terminal control part 133 may change the individual meeting which the attendee terminal 3A attends according to an operation performed in the attendee terminal 3A. In this case, the receiving part 131 receives a designation of a designated individual meeting that is a group meeting different from the individual meeting that the attendee terminal 3A is attending among a plurality of group meetings, while the terminal control part 133 is performing the individual meeting and the general meeting in parallel. The terminal control part 133 causes the attendee terminal 3A to attend the designated individual meeting in response to the receiving part 131 receiving the designation of the designated individual meeting.

As a first method of changing the individual meeting that the attendee terminal 3A attends, the terminal control part 133 starts a new designated individual meeting which the attendee and a user designated by the attendee will attend while the general meeting and the individual meeting are being performed in parallel, for example. On the screen of FIG. 6, a user designation button BT1 for designating a user is displayed in the area R2 for displaying the list of users who are attending the event, for example. The attendee selects the user designation button BT1 corresponding to a user who is desired to be a partner in the individual meeting and is different from the attendee himself/herself.

The receiving part 131 receives a user corresponding to the selected user designation button BT1 as a designated attendee. In response to the receiving part 131 receiving the designation of the designated user, the terminal control part 133 starts the designated individual meeting in which voices are transmitted and received between the attendee terminal 3A used by the attendee and a user terminal 3 used by the designated attendee. As a result, the meeting management apparatus 1 can start a new individual meeting while the general meeting and the individual meeting are being performed in parallel, and can therefore improve the degree of freedom of the event.

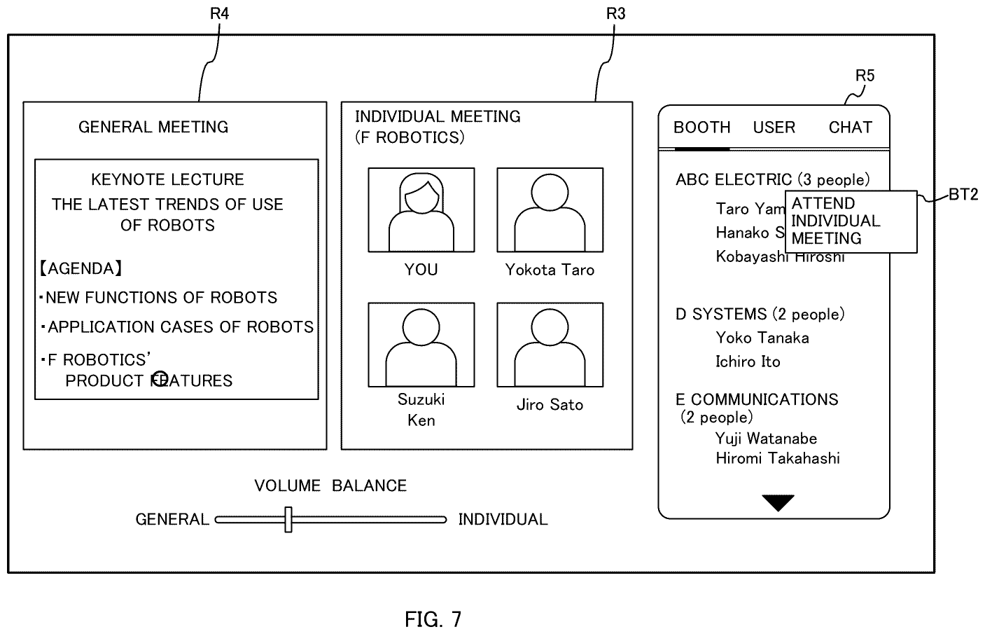

As a second method of changing the individual meeting that the attendee terminal 3A attends, the terminal control part 133 causes the attendee terminal 3A to attend the designated individual meeting designated by the attendee while the general meeting and the individual meeting are being performed in parallel, for example. FIG. 7 shows another example of a screen for displaying data of the individual meeting and the general meeting in the attendee terminal 3A.

The screen of FIG. 7 includes the area R3 for displaying the image data of each of the plurality of users attending the individual meeting, the area R4 for displaying the image data transmitted from the source terminal in the general meeting, and an area R5 for displaying a list of a plurality of group meetings being executed. In the area R5, (i) the names of a plurality of group meetings (e.g., the names of exhibitor companies) and (ii) the names of the users and the number of users attending each of the group meetings are displayed, for example.

On the screen of FIG. 7, a group meeting designation button BT2 for designating a group meeting is displayed in the area R5 for displaying the list of the plurality of group meetings being executed, for example. The attendee selects a group meeting designation button BT2 corresponding to a group meeting different from the individual meeting that he/she is currently attending.

The receiving part 131 receives a group meeting corresponding to the selected group meeting designation button BT2, as the designated individual meeting. The terminal control part 133 causes the attendee terminal 3A to attend the designated individual meeting in response to the receiving part 131 receiving the designation of the designated individual meeting. As a result, the meeting management apparatus 1 enables the attendee to attend another individual meeting while the general meeting and the individual meeting are being performed in parallel, and can therefore improve the degree of freedom of the event.

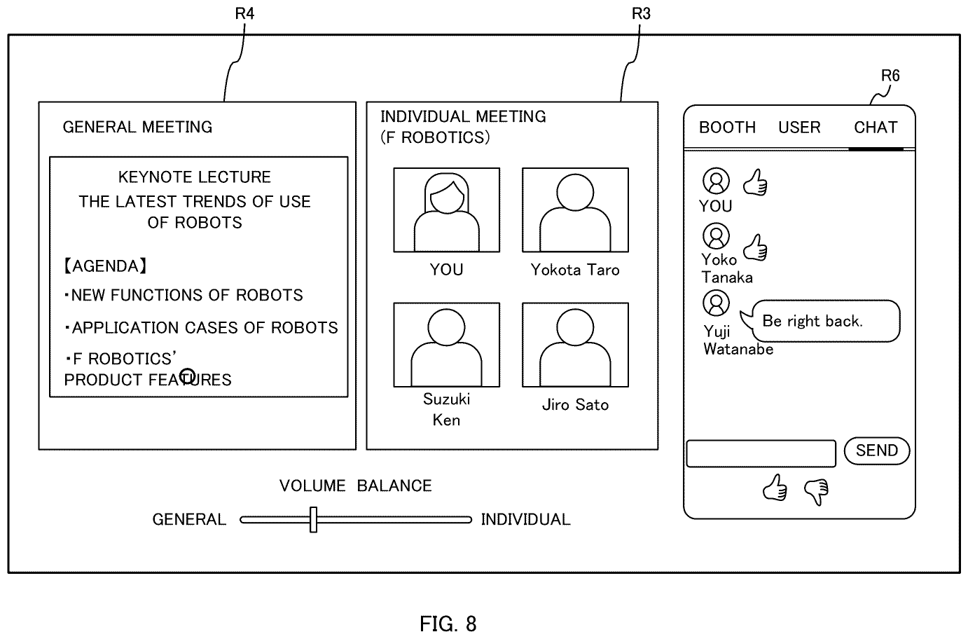

The terminal control part 133 may transmit input data such as a message, an icon, or the like input in an attendee terminal 3A to other user terminals 3 while the terminal control part 133 is performing the individual meeting and the general meeting in parallel. FIG. 8 shows another example of a screen for displaying data of the individual meeting and the general meeting in the attendee terminal 3A.

The screen of FIG. 8 includes the area R3 for displaying the image data of each of the plurality of users attending the individual meeting, the area R4 for displaying the image data transmitted from the source terminal in the general meeting, and an area R6 for displaying input data transmitted by each user terminal 3. In the region R6, an attendee inputs the input data such as a message, an icon, or the like, using the operation part.

The receiving part 131 receives the input data input by the attendee in the attendee terminal 3A. The terminal control part 133 causes the input data to be displayed in the areas R6 in all of the user terminals 3, including the attendee terminal 3A that are attending the general meeting, in response to the receiving part 131 receiving the inputting of the input data. As a result, the meeting management apparatus 1 enables each user attending the general meeting to transmit a message, an icon, or the like, and can therefore facilitate communication between users.

Further, the terminal control part 133 may display the input data in the area R6 on a plurality of attendee terminals 3A that are attending the same individual meeting as the attendee terminal 3A used by the attendee who has input the input data, and does not need to display the input data in other user terminals 3 and the source terminal. As a result, the meeting management apparatus 1 enables the attendee to transmit a message, an icon, or the like to only one individual meeting, and can therefore improve the convenience of communication between attendees.

### [Processing Flow in the Meeting Management Apparatus 1]

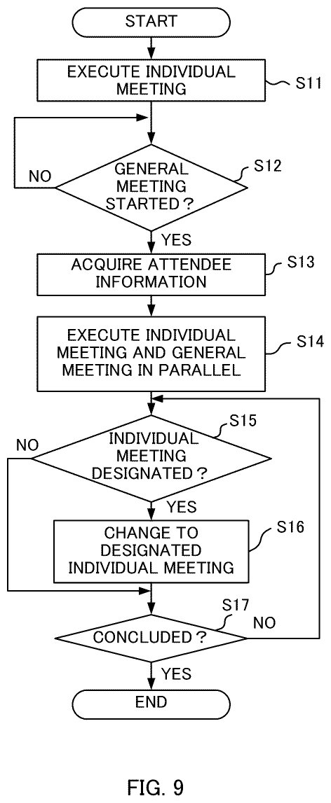

FIG. 9 shows a flowchart showing an example of a flow of processing in the meeting management apparatus 1. The information acquiring part 132 acquires various types of data from an attendee terminal 3A of an individual meeting via the communication part 11. The terminal control part 133 executes the individual meeting by transmitting audio data and image data transmitted from any one of attendee terminals 3A attending the individual meeting to other attendee terminals 3A attending the individual meeting, for example (S11).

The terminal control part 133 continues the individual meeting until the receiving part 131 receives a start operation for starting a general meeting in a source terminal (NO in S12). When the receiving part 131 receives the start operation for starting the general meeting in the source terminal (YES in S12), the information acquiring part 132 acquires, from the storage part 12, attendance information in which (i) an individual meeting which is a group meeting selected from among a plurality of group meetings and (ii) a user terminal 3 attending this individual meeting are associated with each other (S13).

The terminal control part 133 executes an individual meeting for transmitting and receiving voices between the plurality of attendee terminals 3A indicated by the attendance information acquired by the information acquiring part 132 and a general meeting for transmitting voices from a predetermined source terminal to the plurality of user terminals 3 in parallel (S14).

If the receiving part 131 does not receive a designation of a designated individual meeting that is a group meeting different from the individual meeting that the attendee terminal 3A is attending among a plurality of group meetings (NO in S15), the terminal control part 133 proceeds to step S17.

When the receiving part 131 receives the designation of the designated individual meeting which is the group meeting different from the individual meeting that the attendee terminal 3A attends from among the plurality of group meetings (YES in S15), the terminal control part 133 changes the individual meeting which the attendee terminal 3A attends by causing the attendee terminal 3A to attend the designated individual meeting (S16). The designated individual meeting is designated by the attendee specifying another user or another group meeting at the attendee terminal 3A, for example.

The terminal control part 133 continues to execute the general meeting and the individual meeting in parallel until the receiving part 131 receives an operation of concluding the general meeting in the source terminal or an operation of concluding the individual meeting in the attendee terminal 3A (NO in S17). When the receiving part 131 receives the operation of concluding the general meeting in the source terminal or the operation of concluding the individual meeting in the attendee terminal 3A (YES in S17), the terminal control part 133 ends the execution of the general meeting and the individual meeting in parallel. The terminal control part 133 may continue the individual meeting when the general meeting is concluded, and may continue the general meeting when the individual meeting is concluded.

### [Effect of the Meeting Management System S]

The meeting management system S according to the present embodiment acquires, from the storage part 12, the attendance information in which (i) the individual meeting, which is a group meeting selected from among the plurality of group meetings, and (ii) the user terminal 3 attending this individual meeting are associated with each other to execute, in parallel, the individual meeting in which voices are transmitted and received between the plurality of attendee terminals 3A indicated by the acquired attendance information and the general meeting in which voices are transmitted from the predetermined source terminal to all user terminals 3 attending the event. In a conventional group meeting executed via a network, a user could not listen to the general presentation while having conversations with other users, which was inconvenient. On the other hand, the meeting management system S according to the present embodiment enables the user to view the general meeting while having conversations in the individual meeting, and therefore can improve user convenience.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A meeting management apparatus managing a plurality of group meetings that each of a plurality of communication terminals can attend, the meeting management apparatus comprising:
an information acquiring part that acquires information in which (i) an individual meeting, which is a group meeting selected from among a plurality of group meetings, and (ii) a plurality of attendee terminals that are communication terminals attending the individual meeting among the plurality of communication terminals are associated with each other; and
a terminal control part that executes, in parallel, the individual meeting for transmitting and receiving voices between the plurality of attendee terminals and a general meeting for transmitting voices from a predetermined source terminal to the plurality of communication terminals.

2. The meeting management apparatus according to claim 1, further comprising:
a receiving part that receives a designation of a designated individual meeting that is a group meeting different from the individual meeting that the attendee terminal is attending among the plurality of group meetings, while the terminal control part is performing the individual meeting and the general meeting in parallel, wherein the terminal control part causes the attendee terminal to attend the designated individual meeting.

3. The meeting management apparatus according to claim 2, wherein
the terminal control part causes a screen corresponding to the general meeting, together with a list of the plurality of group meetings, to be displayed in the attendee terminal, and the receiving part receives a designation of the designated individual meeting among the plurality of group meetings displayed on the attendee terminal.

4. The meeting management apparatus according to claim 2, wherein
the terminal control part causes a screen corresponding to the general meeting, together with a list of a plurality of users using the plurality of communication terminals, to be displayed in the attendee terminal,
the receiving part receives a designation of a designated attendee who is a user different from an attendee using the attendee terminal among the plurality of users displayed on the attendee terminal, and
the terminal control part starts the designated individual meeting for transmitting and receiving voices between the attendee terminal used by the attendee and a communication terminal used by the designated attendee.

5. The meeting management apparatus according to claim 1, wherein
the terminal control part causes the attendee terminal selected from among the plurality of attendee terminals to exit the individual meeting, and causes the attendee terminal to be the source terminal of the general meeting.

6. The meeting management apparatus according to claim 1, wherein.
the terminal control part causes a communication terminal attending the individual meeting and a communication terminal not attending the individual meeting among the plurality of communication terminals to be displayed in different display modes, in at least one of the attendee terminal or the source terminal.

7. The meeting management apparatus according to claim 1, wherein
the terminal control part disables transmission of at least one of an image or a voice from the attendee terminal to the general meeting on condition that the individual meeting and the general meeting are performed in parallel.

8. The meeting management apparatus according to claim 1, further comprising:
an audio processing part that changes the volume of at least one of the individual meeting or the general meeting in the attendee terminal according to whether the individual meeting and the general meeting are performed in parallel.

9. The meeting management apparatus according to claim 8, wherein
the audio processing part decreases the volume of the individual meeting in the attendee terminal on condition that the general meeting starts during the individual meeting.

10. The meeting management apparatus according to claim 8, wherein
the audio processing part decreases the volume of the general meeting in the attendee terminal on condition that the individual meeting and the general meeting are performed in parallel and that voices are transmitted from any one of the plurality of attendee terminals in the individual meeting.

11. The meeting management apparatus according to claim 1, further comprising:
an audio processing part that removes voices transmitted in the general meeting from voices transmitted in the individual meeting.

12. The meeting management apparatus according to claim 11, wherein
the audio processing part removes the voices transmitted in the general meeting from the voices transmitted in the individual meeting by treating voices transmitted from the source terminal of the general meeting as voices transmitted from the attendee terminal of the individual meeting in an echo cancellation processing performed on voices transmitted from the plurality of attendee terminals.

13. The meeting management apparatus according to claim 1, further comprising:
a receiving part that receives a setting of a single set value corresponding to a ratio of the volume of the individual meeting to the volume of the general meeting from the attendee terminal while the terminal control part is performing the individual meeting and the general meeting in parallel; and
an audio processing part that determines the volume of the individual meeting and the volume of the general meeting in the attendee terminal in accordance with the single set value.

14. A meeting management method for managing a plurality of group meetings that each of a plurality of communication terminals can attend, the method executed by a processor and comprising:
acquiring information in which (i) an individual meeting which is a group meeting selected from among a plurality of group meetings and (ii) a plurality of attendee terminals that are communication terminals attending the individual meeting among the plurality of communication terminals are associated with each other; and
executing, in parallel, the individual meeting for transmitting and receiving voices between the plurality of attendee terminals and a general meeting for transmitting voices from a predetermined source terminal to the plurality of communication terminals.

15. A computer-readable non-transitory storage medium storing a program for managing a plurality of group meetings that each of a plurality of communication terminals can attend, the program causing a processor to execute:
acquiring information in which (i) an individual meeting which is a group meeting selected from among a plurality of group meetings and (ii) a plurality of attendee terminals that are communication terminals attending the individual meeting among the plurality of communication terminals are associated with each other; and
executing, in parallel, the individual meeting for transmitting and receiving voices between the plurality of attendee terminals and a general meeting for transmitting voices from a predetermined source terminal to the plurality of communication terminals.
